(19) United States
(12) Patent Application Publication
(10) Pub. No.: US 2017/0049094 A1
(43) Pub. Date: Feb. 23, 2017

(54) Fly Down Decoy

(71) Applicant: Matthew Townsend Altieri, II, Peninsula, OH (US)

(72) Inventor: Matthew Townsend Altieri, II, Peninsula, OH (US)

(21) Appl. No.: 15/235,480

(22) Filed: Aug. 12, 2016

Related U.S. Application Data
(60) Provisional application No. 62/282,915, filed on Aug. 17, 2015.

(51) Int. Cl. A01M 31/06

(52) U.S. Cl. CPC A01M 31/06

(57) ABSTRACT

The Fly Down Decoy consists of a game bird decoy with a free-floating wheel inside of it. A rope is attached to a pole at a vertical position, then extended horizontally from the pole where it is attached to the ground. This rope runs from the pole through the game bird decoy, running under the wheel inside of the decoy, and to ground level. The wheel inside, allows the decoy to travel freely along the rope from an elevated position to ground level, imitating a game bird flying and landing. Cord, which is secured to the decoy, runs to a retriever and then to the operator. This allows the operator to release the decoy when he/she chooses. The cord also provides the operator the ability to retrieve the decoy back up the rope to be released as often as the operator chooses.

### FIELD

The present application relates to wildlife game decoys, in particular, a game bird decoy with added realism through the use of motion.

### BACKGROUND OF INVENTION

The Fly Down Decoy pertains to the field of art of outdoor recreation. This invention gives outdoorsmen and women a greater opportunity to enjoy their recreational experiences. The added realism this invention provides in the area of decoys ensures that outdoorsmen and women will have a greater opportunity to bring wild animals into close proximity.

The Fly Down Decoy enhances prior works of art (US007562487, US007287352, US007272905, US007076909, US006901693, US006775943, US006775943, US006625919, US006442884, US006708440, US006901693, US006481147, US005459958) by adding movement and realism that has been unattainable in the past. The mechanics of this invention allow this decoy to move in a way that gives the impression of a game bird flying through the air. Although prior works of art (US007562487, US007287352, US007272905, US007076909, US006901693, US006775943, US006775943, US006625919, US006442884, US006708440, US006901693, US006481147, US005459958) give the impression of birds moving, no prior works of art provide actual vertical movement of their decoys from a particular height. This vertical movement ensures that wild game birds will come into closer proximity to this decoy than prior works of art were able to obtain.

### BRIEF SUMMARY

The Fly Down Decoy (overall invention) is comprised of a decoy, free-floating wheel(s), rope, pulley cord, pole and stake. The Fly Down Decoy is able to travel down a rope from a desired height to ground level via the free-floating wheel(s) that is assembled inside of the decoy. The pulley cord allows the operator of the Fly Down Decoy to pull the Fly Down Decoy back up to a desired height and release it to ground level as frequently as the operator chooses. The motion the decoy follows from a vertical position to ground level gives the appearance that the mimicked game bird is flying and landing on the ground.

### BRIEF DESCRIPTIONS OF DRAWINGS

In the following detailed description, the teachings of the present application will be explained in more detail with reference to the example embodiment shown in the drawings, in which:

FIG. 1 is an isometric view of a game decoy according to a first embodiment.

### DETAILED DESCRIPTION OF DRAWINGS

In the following detailed description, the game decoy, according to the teachings of this application in the form of a flying game bird decoy, will be described by the embodiment. It should be noted that although only game birds are described, the teachings of this application can also be used for a variety of game decoys including ducks, geese, other waterfowl species, as well as small and large game animals.

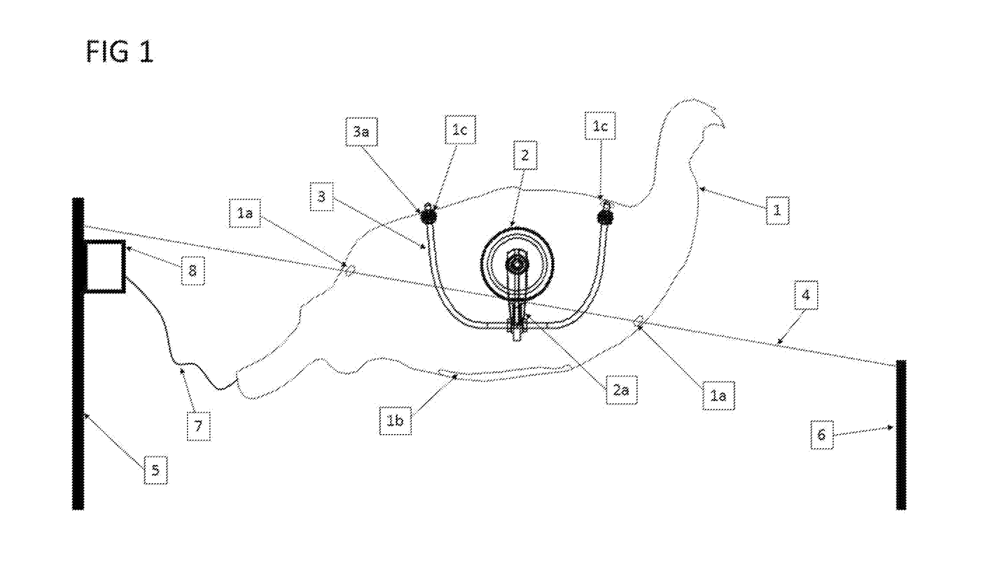

The embodiment of the Fly Down Decoy is illustrated in FIG. 1. The Fly Down Decoy comprises of a game bird decoy (1) with a free-floating wheel(s) (2), that is supported by the wheel supports (3), assembled inside of the decoy. The Fly Down Decoy also comprises of a fly down rope (4) which is connected to a pole (5), run through the game bird decoy (1) and free-floating wheel(s) (2), and then connected to a stake (6) secured to the ground. A pulley cord (7) is connected to the tail end of the decoy (1) and run to the retriever (8).

In the present embodiment, the game bird decoy (1) is a hollow decoy with small holes in the rear and front of the decoy (1a) to allow the fly down rope (4) to be run through the decoy from the rear to the front. A large hole (1b) located at the bottom of the decoy allows the free-floating wheel(s) (2) and wheel supports (3) to be placed inside of the decoy. Two small holes (1c) located at the top of the decoy, allow the wheel supports (3) to be secured to the game bird decoy (1).

In this embodiment the free-floating wheel(s) (2) and wheel supports (3) are placed into the game bird decoy (1) through the large hole (1b) located at the bottom of the game bird decoy (1). The wheel supports (3), which project above the free-floating wheel(s) (2), are then placed through the two small holes (1c) located at the top of the decoy, allowing the wheel supports (3) to be secured to the game bird decoy (1). Stoppers (3a) are placed at the top of the wheel supports, preventing the game bird decoy (1) from the sliding down the wheel supports (3). The free-floating wheel(s) (2) is connected to the wheel supports (3) via the saddle (2a). The saddle (2a) allows the wheel (2) to sit firmly and freely in the game bird decoy (1).

In the present embodiment, the fly down rope (4) allows the game bird decoy (1) to travel down from a vertical position to ground level. The fly down rope (4) is attached to the top of the pole (5). The fly down rope (4) is then run through the small eyelet hole (1a) located at the rear of the game bird decoy (1). Following this, the fly down rope (4) is run under the wheel(s) (2) and then through the small eyelet hole (1a) located at the front of the game bird decoy (1). Finally, the fly down rope (4) is tied to a stake (6) which is secured firmly into the ground. The fly down rope (4), which is tight from tension between the pole (5) and the stake (6), allows the game bird decoy (1) to travel down from the top of the pole (5) to ground level via the free-floating wheel(s) (2) inside the game bird decoy (1). This gives the impression of a game bird flying and landing on the ground.

In this embodiment, the pulley cord (7) is attached to the tail end of the game bird decoy (1). The pulley cord is then run to the retriever (8). The pulley cord (7) allows the operator of the Fly Down Decoy to send the decoy down the fly down rope (4) by releasing the pulley cord when the game bird decoy (1) is located at the top of the fly down rope (4). The operator is also able to bring the game bird decoy (1) back up to the top of the pole (5) by activating the retriever (8) until the game bird decoy (1) travels up the fly down rope (4) to the desired height.

The various aspects of what is described above can be used in a variety of game decoys. The embodiment can be used for turkey, duck, geese, dove, as well as all waterfowl game bird decoys. The Fly Down Decoy may also be used as a small game decoy (rabbit, hare, squirrel, pheasant, etc.), providing the operator of the Fly Down Decoy the opportunity to attract predators such as wolves, coyotes, foxes, bobcats, and panthers. Similarly, the Fly Down Decoy can be used as a large game decoy (deer, boar, antelope, elk, goat, etc.), providing the operator of the Fly Down Decoy the opportunity to attract large wild game species. In such situations, the operator would position the Fly Down Decoy only a few feet off of the ground and release the Fly Down Decoy to mimic a game animal jumping and landing on the ground.

The versatility of the Fly Down Decoy is not only limited to the type of wild game being portrayed through the decoy itself, but it can also be used in different types of habitats. Not only can the Fly Down Decoy be used in a wooded habitat, but the system may also be used in an open field or agricultural field. Due to the pole (5), the Fly Down Decoy has the ability to be elevated to a desired height without the presence of any trees. The pole (5) is able to be driven into the ground in any open field or prairie. Additionally, the stake (6) tied to the end of the fly down rope (4) may be secured to the ground in this open area, providing the tension needed for the Fly Down Decoy to travel down the fly down rope (4) via the free-floating wheel(s) (2) inside of the decoy. This will therefore allow the operator of the Fly Down Decoy to position game decoys at an elevated height. From this elevated position, the operator is able to release the game decoy, giving the impression that the game decoy is flying and landing in this open area.

The Fly Down Decoy may also be used in bodies of water such as in wetland habitats. The pole (5) is able to be driven into the ground in water depths up to several feet deep. Additionally, the stake (6) tied to the end of the fly down rope (4) may be secured to the ground of this body of water, providing the tension needed for the Fly Down Decoy to travel along the fly down rope (4) via the free-floating wheel(s) (2) assembled inside of the decoy. This will therefore allow the operator of the Fly Down Decoy to position waterfowl decoys at an elevated height above a body of water. From this elevated height, the operator is able to release the waterfowl decoy, giving the impression that the waterfowl decoy is flying and landing in the water.

The teachings of this application have multiple advantages. One of these advantages is the way the Fly Down Decoy mimics a game bird flying and landing. In doing so, the Fly Down Decoy attracts wild game birds and brings them into closer proximity of hunters or wildlife viewers. The realistic movement the Fly Down Decoy makes when traveling down the fly down rope (4) is made capable via the free-floating wheel(s) (2) inside of the decoy (1). The motion made when the Fly Down Decoy travels down the fly down rope (4) tricks wild game birds into thinking the Fly Down Decoy is another bird of the same species flying and landing on the ground. In doing so, wild game birds are given the impression that food or mating opportunities are available.

A second advantage of the Fly Down Decoy is the opportunity the free-floating wheel(s) (2) provide in regards to both down and up motions. The pulley cord (7) gives the operator of the Fly Down Decoy the opportunity to release the Fly Down Decoy at a particular height. In doing so, the Fly Down Decoy travels down the fly down rope (4), via the free-floating wheel(s) (2) inside of the decoy (1). The motion the Fly Down Decoy makes when traveling down the fly down rope (4) mimics the motion a game bird makes when flying and landing on the ground. The pulley cord (7) also provides the operator the opportunity to pull the Fly Down Decoy back up to the top of the fly down rope (4) to be released again. In doing so, the operator of the Fly Down Decoy is able to release the Fly Down Decoy as many times as the operator chooses. The opportunity the free-floating wheel(s) (2), pulley cord (7), and retriever (8) provide in allowing the operator of the Fly Down Decoy to release the decoy (1) as many times as he/she chooses ensures that hunters and wildlife viewers can attract desired wildlife on multiple occasions while in the outdoors.

A third advantage of the Fly Down Decoy is the opportunity the Fly Down Decoy provides relative to concealment of its operator. The pulley cord (7) gives the operator of the Fly Down Decoy the ability to operate the Fly Down Decoy from a distance away. This is made capable through the length of the pulley cord (7) itself. The pulley cord (7), which is secured to the tail end of the decoy (1) and run to the retriever (8), can be extended to the operator of the Fly Down Decoy at a position that is far from where the decoy (1) will land. This provides the operator of the Fly Down Decoy the ability to stay hidden from the wild game he/she is trying to attract.

Although the teachings of this application have been explained in great detail in order to describe the presented illustrations, it should be noted that these details are strictly for this purpose, and different variations of the teachings can be developed by those trained and skilled in the art without leaving the scope of the teachings of this application. For example, the Fly Down Decoy has been described as a decoy (1) with a free-floating wheel (2) inside of it that allows the decoy (1) to travel down a rope, but it is understood that the decoy (1) can have multiple free-floating wheels (2) inside of it aiding in its vertical movement on the rope. Further, the Fly Down Decoy has been described as a decoy (1) that mimics a game bird flying and landing on the ground, but it is understood that the decoy (1) can also land in water or other habitats.

A third example would be in the appearance of the decoy (1) itself. The Fly Down Decoy has been described as a game bird decoy (1) mimicking the motions of a wild game bird flying and landing on the ground, but it should be noted that the decoy (1) may also appear as a small or large game animal jumping in the air and landing on the ground. This is made possible when the operator of the Fly Down Decoy positions the decoy (1) a few feet off of the ground and releases the decoy to travel down the rope to ground level.

It should be noted that there are multiple ways of implementing the specifications, design aspects, and functions of the teachings of this application.

Although emphasis is made on a few particular aspects of the Fly Down Decoy in the teachings of this application, it should be understood that the applicant claims protection of any and all patentable features, or combination of features, referred to in the teachings of this application and or shown in the drawings.

The term “comprising” as used in the claims does not exclude elements or steps. The term “a” or “an” as used in the claims does not exclude a plurality. A unit or other means may fulfill the functions of several units or means recited in the claims.

1. A device comprising of a wild game decoy, wherein the body of the wild game decoy has a free floating wheel(s) assembled inside of it.

2. A device according to claim 1, wherein the wheel(s) inside of the decoy is connected to the wild game decoy through supports that extend vertically from the wheel(s) to the top of the wild game decoy.

3. A device according to claim 1, wherein the wild game bird decoy has two small holes on the top of the decoy for the supports running vertically from the wheel(s) to be placed in.

4. A device according to claim 2, wherein the supports running vertically from the wheel(s) have small structures at the top of them that run horizontally, stopping the wild game decoy from sliding down the supports.

5. A device according to claim 1, wherein the wild game decoy has two small holes located at the rear and front of the decoy.

6. A device according to claim 5, wherein the wild game decoy has a rope or cord running through the wild game decoy via the rear and front holes.

7. A device according to claim 5, wherein the wild game decoy has a rope or cord which runs through the rear hole of the decoy, under the free-floating wheel(s) inside of the decoy, and then through the front hole of the decoy.

8. A device according to claim 7, wherein the rope running through the wild game decoy is attached to a pole, elevating the back end of the rope to a vertical position.

9. A device according to claim 7, wherein the front end of the rope running from the pole and through the wild game decoy is attached to the ground, lowering the front end of the rope and creating a decline in the angle of the rope.

10. A device according to claim 1, wherein the tail end of the decoy has a pulley cord attached to it.

11. A device according to claim 10, wherein the pulley cord attached to the tail end of the wild game decoy is run to a retriever.

12. A device according to claim 11, wherein the operator is able to use the retriever to release and retrieve the wild game decoy up and down the rope.
